(19) United States
(12) Patent Application Publication
(10) Pub. No.: US 2012/0303428 A1
(43) Pub. Date: Nov. 29, 2012

(54) Tradesmans purchase system

(76) Inventor: Steve Mewmark, Florham Park, NJ (US)

(21) Appl. No.: 13/134,011

(22) Filed: May 26, 2011

(51) Int. Cl. G06Q 30/00; G06F 7/04; G06Q 40/00

(52) U.S. Cl. 705/14.15; 705/14.1; 705/14.38; 705/35; 340/5.83; 340/5.84

(57) ABSTRACT

A Tradesman's Purchase system is operated by a bank or credit issuing authority that issues a Tradesman's purchasing credit unique ID# to qualifying tradesman selected from the group consisting of plumbers, electricians, carpenters, masons, mechanics, repair shop professionals, contractors, or related construction or trade companies and professions upon payment of an initiation fee and payment of periodic maintenance fees. The unique ID# provides pre-negotiated discount levels for tradesmen within the group contracted with pre-selected wholesalers, jobbers and businesses. The unique ID# is linked to the tradesman's name, business, professional status, license number and biometric data including palm print, finger print, iris print and voice print. Professional purchases by the tradesman are tracked by the system, analyzed and reported to sponsoring manufacturers of goods, jobbers or wholesalers for a fee. The purchasing information can be used for marketing purposes and generation of special discounts on future purchases by the tradesmen.

### BACKGROUND OF THE INVENTION

1. Field of the Invention

The present invention relates to credit purchase systems; and, more particularly, to a tradesman's purchase system issued by a bank or credit issuing authority that is capable of providing unique services for a tradesman in connection with the purchase of professional goods or services from a wholesaler or jobber that recognizes the tradesman as a certified and or qualified buyer and member of a particular field.

2. Description of the Prior Art

Many patents address issues related to financial accounting systems and credit card methods and payment options. These prior art disclosures focus on computer systems that monitor payment behavior or provide payment options or use of secondary codes for using credit card transactions in an unsecured network. None of these patents discloses a credit purchase system that is specifically designed for a tradesman that purchases a large amount of trade specific supplies; none of them recognizes the tradesman as a member of a unique profession and provides a special discount or incentives in connection with the purchase.

U.S. Pat. No. 5,875,435 to Brown discloses an automated accounting system. This is an automated accounting system for an entity, such as an individual or business. This system merely posts a particular business transaction under proper accounting codes and generates accounting reports. This system does not issue a tradesman's credit card that is specific to a tradesman selected from a group consisting of plumbers, electricians, carpenters, masons, mechanics, repair shop professionals, contractors, or related construction or trade companies, and professionals such as a doctor in a hospital supply retailer or a attorney in a stationary supply house or the like that provide unique discounts.

U.S. Pat. No. 5,878,141 to Daly et al. discloses a computerized purchasing system and method for mediating purchase transactions over an interactive network. This system has a list comprising a number of payment methods available for the purchaser, including cash, check, Discover, Visa, master Card, and American Express card and a second list comprising the merchant payment acceptance options of different payment methods. This purchasing system compares these two lists to find a matching payment option and presents all potential payment options to the purchaser for selection and purchase processing. The purchaser is not indicated to be a tradesman selected from a group consisting of plumbers, electricians, carpenters, masons, mechanics, repair shop professionals, contractors, or related construction or trade companies and professionals. Also, this system does not offer pre-negotiated discounts to a tradesman purchaser.

U.S. Pat. Nos. 6,985,608 and 7,248,719 to Hoffman et al. disclose a tokenless electronic transaction system. This method and system involve tokenless authorization of commercial transactions between a buyer and a seller using a computer system. The method comprises the steps of registering a buyer, wherein the buyer registers with the computer system a PIN, at least one registration biometric sample, and at least one buyer financial account. The method also includes a seller registration step, wherein the seller registers with the computer system at least one seller financial account. In a proposal step, the seller offers a proposed commercial transaction to the buyer usually comprising price information. If the buyer accepts the seller's proposal, in an acceptance step, the buyer signals his/her acceptance by adding to the proposed commercial transaction the buyer's personal authentication information comprising a PIN and at least one bid biometric sample which is obtained from the buyer's person. In a transmission step, the bid biometric sample and PIN are forwarded to the computer system. The computer system compares the bid biometric sample with registration biometric samples for producing either a successful or failed identification of the buyer in a buyer identification step. Upon determination of sufficient resources, a financial account of the buyer is debited and a financial account of the seller is credited, in a payment step. Therefore, a commercial transaction is conducted without the buyer having to use any portable man-made memory devices such as smartcards or swipe cards. The systems disclosed by the '608 and '719 patents do not provide discounts to a Tradesman at pre-negotiated merchant locations.

U.S. Pat. No. 7,086,590 to Yamagami et al discloses a pay-by-card method and pay-by-card system for home delivery service. A customer orders merchandise on the Internet at a seller web site, after which a pre-arranged delivery service picks up the merchandise and delivers it to the door of the customer. The customer presents a credit card to the delivery person who processes the credit card payment in a portable device. No requirement exists that the consumer be a tradesman selected from a group consisting of plumbers, electricians, carpenters, masons, mechanics, repair shop professionals, contractors, or related construction or trade companies and professions. The system disclosed by the '590 patent does not offer pre-negotiated discounts to a tradesman purchaser. In addition, the seller is not a wholesaler or a jobber.

U.S. Patent Application No. 2002/0035520 to Weiss discloses a property rating and ranking system and method. This is an automated system that assesses the existing property of a borrower and evaluates existing loans to set the amount of unsecured debt available in a credit card. The borrower is not indicated to be a tradesman selected from a group consisting of plumbers, electricians, carpenters, masons, mechanics, repair shop professionals, contractors, or related construction or trade companies and professions. Also, this system does not offer pre-negotiated discounts to a tradesman purchaser.

U.S. Patent Application 2003/0093322 to Sciuk discloses an automated system and method for managing a process for the shopping and selection of human entities. This system and method is for automatically managing a multi-step process in which human providers are selected for some purpose. Typical applications include the selection process associated with employment and dating services. The automated system creates matches between purchasers and providers based on the requirements of the purchaser and declared capabilities of the provider, and these criteria may be verified through a filtration process and/or interview and engagement process. This disclosure does not contemplate a tradesman card with credit capability that provides pre-negotiated discounts to a tradesman during purchase of merchandise.

U.S. Patent Application 2003/0236753 to Ljungqvist discloses a method of safe mediation of payment in connection with network commerce. The payment for purchase of a product from a supplier by a customer is negotiated through an independent party that communicates with a commercial establishment that is affiliated with the customer. When the appropriate communication is received, the supplier is assured that payment will be made immediately or at a later time and extends credit to the customer for the purchase of a product. This '753 patent disclosure does not disclose a method for effecting purchases by a tradesman selected from a group consisting of plumbers, electricians, carpenters, masons, mechanics, repair shop professionals, contractors, or related construction or trade companies and professions offering a pre-negotiated discount on trade merchandise acquired by a tradesman purchaser.

U.S. Patent Application 2004/0158532 to Breck et al. discloses a system for facilitating a transaction. The system provides the card holder with a second identification which when used in combination with a credit card provides instant authorization of a credit card purchase through unsecured networks. Since the secondary identification number is provided by the card provider and is approved by the card user, for all practical purposes, knowledge of the second identification number instantly accesses the credit card. However, the '532 disclosure states that the second identification number is not usable in itself but immediate credit purchase is authorized only by communicating the second identification number even through an unsecured network. This '532 disclosure does not contemplate purchases by a tradesman from a group consisting of plumbers, electricians, carpenters, masons, mechanics, repair shop professionals, contractors, or related construction or trade companies and professions Neither does the '532 disclosure contemplate pre-negotiated discounts to a tradesman purchaser.

U.S. Patent Application 2005/0144100 to Shapiro et al. discloses payment systems and methods for earning incentives using at least two financial instruments. This system uses two borrowing sources a first standard principal borrowing source with no incentives offered, and a second borrowing source which provides borrowing incentives. The first party paying a second party borrows funds of a first amount from the second incentive source, collecting the incentive. Next, the first amount is borrowed from the first standard principal source and the borrowed money is used to pay off the debt of the second incentive borrowing source. This system provides an incentive for the first party by manipulating funds between two borrowing sources. It does not provide a discount offered by a wholesaler or jobber to a tradesman.

U.S. Patent Application 2005/0197954 to Maitland et al. discloses methods and systems for predicting business behavior from profiling consumer card transactions. This system and method provides for predicting small business behavior by analysis of consumer payment card transaction data to determine if a consumer credit card is used for small business purchases. This system merely accumulates data on the use of a consumer credit card and analyzes the data for credit card usage behavior that matches the behavior of a small business. This information is needed for the credit card issuing authority to solicit new business services from the small business that routinely uses a consumer credit card for business purchases. This '954 disclosure does not disclose purchases by a tradesman from a group consisting of plumbers, electricians, carpenters, masons, mechanics, repair shop professionals, contractors, or related construction or trade companies and professions.

U.S. Patent Application 2005/0251448 to Gropper discloses a business card and contact management system. This system is activated by a special card that carries a universal contact locator. The remote server collects contact information, advertisement and news specific to the user with the special card and transfers this information from the remote server to the client computer. A special downloaded program in the client computer displays the contact list, advertisement information and news information. This '448 application disclosure does not suggest a tradesman card usable by professionals consisting of plumbers, electricians, carpenters, masons, mechanics, repair shop professionals, contractors, or related construction or trade companies or professionals for purchasing merchandise. This system does not offer pre-negotiated discounts to a tradesman purchaser.

U.S. Patent Application 2005/0267776 to Selby et al. discloses a combo kit and method of providing a combo kit. This combo kit selection system and methods are operable to facilitate the configuration and purchase of a power tool combination kit. This is a combo kit with a battery, battery charger and a number of power tools selected by the customer. This '776 disclosure does not suggest a tradesman card used for purchases by a tradesman from a group consisting of plumbers, electricians, carpenters, masons, mechanics, repair shop professionals, contractors, or related construction or trade companies or professionals.

U.S. Patent Application 2006/0053132 to Litzow et al. discloses a system and method for dynamic price setting and facilitation of commercial transactions. This system collects customer data of purchases, customer payment preferences and vendor data including type of bundles and prices. This collection of data is analyzed to extract demographic group profiles and provides means to optimize offerings to individual groups of customers. This data collection system is not a tradesman card that provides a discount for professional purchases of tradesman from a group consisting of plumbers, electricians, carpenters, masons, mechanics, repair shop professionals, contractors, or related construction, trade companies or professionals.

U.S. Patent Application 2007/0038563 to Ryzerski discloses systems and methods for managing buildings and finances. A stand-alone computer system keeps track of consumables in a building such as use of oil, propane, water, electric, food, and the like. This system does not contemplate use of a Tradesman card system; it does not provide pre-negotiated discounts at pre-selected wholesalers or jobbers for purchases made by a tradesman.

Foreign Patent Application Publication JP2001229264 to Kabamoto discloses a credit/certification business system by a smart card, and a smart card used for the same. A smart card evaluates the credit limit as the smart credit card is used for purchases. The customer is provided with a new, modified credit limit as purchases and payments are made. This business system does not contemplate use of a Tradesman card.

Foreign Patent Application Publication WO200167318 to Sanda discloses a settlement method and settlement system. A data center has a database that includes a customer's credit card number and a mobile phone number in a correlated manner. The data center is registered with an authorization service network for credit card purchases and includes a number of goods/service shops. When a customer makes a purchase, the customer transmits the card settlement information to the data center using the mobile phone. The data center contacts a credit card company and the purchase is authorized without using a credit card. This business system disclosed by the '318 patent application does not suggest a Tradesman card system.

Non-Patent Publication entitled ““The Home Depot Business ToolBox: Index” at https://www.hdbusinesstoolbox.com/default.aspx discloses a Home Depot Business ToolBox, which comprises Health Insurance and Benefits, Wireless Telecommunications, Business Insurance, Payroll Processing, Computers and Technology, Shipping, Printing and Copying, Dumpster Rentals, Logo Wear and Apparel, Business Mgmt Software, Temporary Storage Solutions and Credit Card Processing. This Home Depot Business ToolBox provides businesses with time saving management tools and significant savings on many business services that are in use everyday. This business service does not issue a Tradesman Card to tradesman selected from a group consisting of plumbers, electricians, carpenters, masons, mechanics, repair shop professionals, contractors, or related construction or trade companies. Moreover, the business service disclosed by the Home Depot Business ToolBox Publication does not contemplate pre-negotiated discounts for merchandise purchased by a tradesman at pre-selected wholesaler or jobber locations.

There remains a need in the art for a tradesman purchase system that recognizes a tradesman as a part of specialized group of professionals consisting of plumbers, electricians, carpenters, masons, mechanics, repair shop professionals, contractors, or related construction, trade companies and professions that purchase a large volume of trade supplies from wholesalers and use specialized services of jobbers deserving specialized treatment, including discounts. There additionally exists a need for a tradesman's purchase system wherein wholesalers and manufacturers offer revised discount levels or provide additional discounts for tradesmen purchases based on volume, brand and the like, without the Tradesman having to carry a card.

### SUMMARY OF THE INVENTION

The present invention provides a Tradesman's purchase system issued by a bank or credit issuing authority appointed for distribution solely to trade professionals selected from the group consisting of plumbers, electricians, carpenters, masons, mechanics, repair shop professionals, contractors, related construction or trade companies and or professions. The Tradesman's purchase system is used for purchases made at professional trade companies, including wholesalers or jobbers. It is capable of providing a unique service for a tradesman, including pre-negotiated discounts on tradesman purchases at pre-selected wholesaler or jobber locations, according to negotiations set forth by the bank or credit issuing authority. In addition, the bank or credit issuing authority of the Tradesman's purchase system has sponsorship relationship with manufacturers of goods; wholesalers and jobbers to provide a feedback regarding tradesman trade supply purchases. This feedback information may be tracked by the bank or credit issuing authority. Aggregate information concerning the tradesman purchasing preferences can then be sold to these sponsorship entities. This information is extremely valuable to manufacturers of goods, wholesalers and jobbers, since they form part of the business strategies of these sponsoring entities. Manufacturers, wholesalers or jobbers can use this information to establish additional incentives such as targeted discounts and the like, to entice the tradesman to use specific merchandise or service.

When a tradesman subscribes to a Tradesman's Purchase System, an initiation fee is paid and the tradesman is issued access to a Tradesman's Purchase System that has a unique identification number, together with biometric information uniquely logged within the purchase system. The identification system may include an expiration date as well as a security code in a manner similar to that used by credit cards. The biometric information may be one or more combinations of face recognition, finger print recognition, palm print recognition, voice print recognition. In effect, the Tradesman needs to provide the unique identification number and optionally the security code and expiration date and validate the identity of the Tradesman purchaser through biometric parameters. The charges for the purchases are logged into the credit issuing authority of a valid purchase at a location that has pre-negotiated Tradesman discounts and the Tradesman receives appropriate credits accordingly. The merchant is provided with information on the purchases made by the authorized Tradesman according to the Tradesman qualifications thereby promotional discounts may be provided by the merchant on a timely manner. The tradesman needs to sign an agreement with the credit issuing authority authorizing the divulgence or disclosure of the purchases made by the tradesman to a third party. This permits the bank or credit issuing authority to disclose the purchase patterns of a tradesman of a particular trade in an agglomerated or detailed format to manufacturers of goods, wholesalers and the like. By this mechanism, the Tradesman Purchase System agreement authorizes release of purchasing information. Manufactures wishing to increase their business through acquisition of new customers can procure this valuable information for an agreed upon consideration. Wholesalers and distributors can thereby increase their business with new customers without having to finance the additional accounts receivables. The Tradesman's Purchase System has the initiation date of the membership and its expiration data along with a security code associated with the unique identity number. The identity number is also associated with a particular group with a level of trade proficiency and this information is stored within the System. The tradesman belonging to the Tradesman Purchase System must make periodic payments to maintain his status as a member of the Tradesman's Purchase service. The status for the tradesman is stored within the Tradesman's Purchase System and is verified each time the Tradesman makes purchase at a location that has negotiated discounts. The Tradesman may use any location that has no pre-negotiated discounts for making purchases but this purchase occurs similar to a credit card purchase without any discount benefits. The Tradesman's Purchase System includes: (i) a Tradesman signing up with a credit issuing authority validating the Tradesman's professional affiliation, status and professional rank including a professional license number enabling purchase discounts of professional purchases from pre-negotiated merchant locations or services; (ii) the credit issuing authority collecting and storing biometric data comprising eye iris scan data, fingerprint data, palm print data, face recognition data and voice recognition data of the Tradesman and storing the data within the Tradesman Purchase System along with the name of the Tradesman and issuing a unique identification number; (iii) said professional affiliation being a member selected from a group consisting of plumbers, electricians, carpenters, masons, mechanics, repair shop professionals, contractors, or related construction or trade companies and professions. Upon initiation, the tradesman is provided with a list of wholesalers and jobbers that provide a discount under the Tradesman's Purchase System Service. For each of these wholesalers, a pre-negotiated amount of discount is indicated. The Tradesman is provided with a unique identification number, along with security codes. At the time of purchase, all that the Tradesman has to do is to provide the unique identification number, and optionally the expiration data end security code, and provide biometric proof such as finger print scan, palm scan eye iris scan, face recognition or voice recognition. This validates that the purchaser of the products is the authorized Tradesman and is entitled to pre-negotiated discounts. The Tradesman's Purchase system, which is issued by a bank or a credit issuing authority, validates the purchase and automatically applies a pre-negotiated discount for the purchase at pre-negotiated wholesalers or jobbers. However, a tradesman's purchase of goods from other merchants that are not part of the Tradesman's Purchase System provides no discount, and the purchases made using Tradesman's Purchase System works in a manner similar to that of a standard credit card. This Tradesman's Purchase System uniquely identifies the tradesman as a professional, not a home owner performing occasional repairs and the like, and elevates the status of the tradesman by providing enhanced services and discounts at pre-negotiated wholesaler and jobber locations. The tradesman may receive periodic discounts from manufacturers, wholesalers or jobbers to support specific products or services by virtue of belonging to the Tradesman's Purchase System. This system also prevents the use by a person other than the Tradesman for the credit purchases and receive pre-negotiated discounts since the biometric data needs to be verified before any purchase or discounts are authorized.

The Tradesman's Purchase System provides a tradesman with a purchasing system and method for purchasing goods or services from a wholesaler or jobber at a specialized discount, comprising: (i) a tradesman's credit authorization that is issued to a tradesman; (ii) the Tradesman Purchase system acquiring tradesman specific information, including a license number, type of trade or profession indicated as a textual representation of trade, (iii) an identification number indicating that the tradesman belongs to the discount tradesman network, and (iv) the initiation date of membership while the expiration date of membership is updated within the Tradesman Purchase System. In a preferred embodiment, the Tradesman's Purchase authorization may be issued by a credit issuing bank in combination with a unique identification number and biometric data. The use of the credit authorization for purchase generates appropriate discounts at pre-selected wholesaler or jobber locations, thereby creating a transaction that computes appropriate pre-negotiated discount levels. Since this Tradesman's Purchase System is passed through standard credit handling machinery, the merchant is generally provided with a transaction box that is connected to the cash register machine. Upon providing the unique identification number and optionally the expiry date and security pin, the biometric system at the merchant location verifies the authenticity of the Tradesman permitting the charge purchase. The transaction box adjusts the purchase price for good and services, as determined by the cash register machine, in accordance with pre-negotiated discount amounts and types of merchandise purchases, so that the final bill reflects these pre-negotiated discounts. Each purchase is registered through the Tradesman Purchase system along with the details of merchandise for which a pre-negotiated discount is applied. The purchasing information reflects the discounts applied to purchases by the tradesman, and is available for communicating back to the wholesaler, jobber or a manufacturer that sponsors the Tradesman's Purchase System. The manufacturer receives updates of specific details on the purchase behavior of the tradesman in periodic intervals after payment of a fee. This allows the manufacturer to provide discounts to the tradesman for supporting the manufacturer's products, or to alter advertising strategies.

Generally stated, the invention comprises a Tradesman's Purchase System that includes a bank or credit issuing authority capable of providing a unique service for a tradesman selected from the group consisting of plumbers, electricians, carpenters, masons, mechanics, repair shop professionals, contractors, and related construction or trade companies and professions. These tradesmen purchase substantial amounts of merchandise in the course of their work, and use for their purchase specialized wholesalers or jobbers. The bank or credit issuing authority negotiates with wholesalers and jobbers for discount levels applied to tradesman trade related purchases using the Tradesman's Purchase System. A number of manufacturers may sponsor the Tradesman's Purchase System and may be involved in receiving on a periodic basis the details of purchases made by tradesmen in practicing their profession, thereby creating a ground level view depicting market acceptability of a manufacturer's product. The manufacturer may influence the purchases made by the tradesman for using their trade by offering a discount or incentive as well as changing the advertisements in the media to control the overall acceptance of the manufacturer's product.

When equipped with the attributes of the present invention, The Tradesman Purchase System becomes a marketing tool for trade's people. Importantly, it identifies the user as a certified and or qualified buyer, and member of a particular field. Upon fitting the profile for the Tradesman Purchase System, a buyer becomes eligible for the privileges of others in that field. These privileges can include special discounts, bonuses and premiums. Purchases by a credit holder are tracked by the Tradesman's Purchase System and provided to manufacturers or wholesalers so that other offers can be granted. Information derived from this tracking capability has significant value for manufacturers of purchased products. Consider, for example, the case of a mechanic holding a credit authorization wherein Brand M is the Tradesman Purchase System sponsor, and making large volume purchases of brand G shock absorbers. In this situation, the Tradesman Purchase System sponsor (Brand M) can make the credit holder a generous offer to switch brands in the future. This advantageous relationship between a Tradesman Purchase System sponsor and a credit holder extends into other fields. For example, it could be used to differentiate decorators going to furniture and wall covering showrooms from persons doing their own decorating. Flower and gift shop personnel going into show rooms can be identified as true shop owners. Food and equipment wholesalers can identify and extend benefits to a true restaurateur. A carpenter from a remote location within a state that runs short of 2×4s can go to the local lumber yard that belongs to the Tradesman's Purchase System, and be qualified to purchase at that yards wholesale prices. The carpenter is accorded a significant convenience, and the lumberyard gains an opportunity to acquire a new volume customer. A doctor on vacation needs some medical supplies can go to a medical supply store and be accorded discounts and courtesies related to their field.

Some of the larger fields for which The Tradesman Purchase System is especially well suited include, for example: (i) within the construction field all of the special trades; (ii) agriculture, farming, landscaping, and the like; (iii) service people; janitorial, pools, specialty services such as telephone and IT.

### BRIEF DESCRIPTION OF DRAWINGS

The invention will be more fully understood and further advantages will become apparent when reference is had to the following detailed description and the accompanying drawings, in which:

FIG. 1 illustrates schematically the steps involved in the set up of the Tradesman's Purchase System at a credit issuing authority;

FIG. 2 illustrates schematically the steps involved at the Tradesman goods and service purchase location.

### DESCRIPTION OF THE PREFERRED EMBODIMENTS

This invention relates to a Tradesman Purchase System tailored for use by tradesmen. Briefly stated, the Tradesman's Purchase System membership is solely restricted to trade professionals selected from the group consisting of plumbers, electricians, carpenters, masons, mechanics, repair shop professionals, contractors, related construction or trade companies and professions, for purchases made at professional trade companies, including wholesalers or jobbers. The Tradesman's Purchase System provides a tradesman with a Tradesman credit purchasing system and method for purchasing goods or services from a wholesaler or jobber at a specialized discount. It recognizes the profession of the tradesman as being distinct from that of a home owner that engages in occasional repairs.

There are approximately two million trade companies, including plumbers, electricians, carpenters, masons, repair shops, and the like, employing approximately five million employees. Billions of sales dollars are generated by these electric, plumbing and construction related businesses and professions through the purchase of vital supplies, parts, materials, tools and services. More than five hundred thousand wholesalers or jobbers service this expanding market. With so many do-it-yourselfers, it is becoming increasingly difficult for wholesalers or jobbers to distinguish skilled trade professionals from amateurs. As a result, wholesalers or jobbers cannot immediately recognize and track purchase and spending of the professionals, and cannot offer specific purchase incentives to these large volume purchasers. Moreover, the tradesmen themselves should be recognized and distinguished from the do-it-yourselfer home repairperson to validate the importance of their craft.

The Tradesman Purchase System readily distinguishes the professional tradesman from the do-it-yourself home repair individual. Advantageously, The Tradesman Purchase System provides the ability for a jobber or wholesaler/supplier to immediately recognize the purchaser as a professional in the trade field. Recognition of professional tradesmen purchasers allows the jobber or wholesaler to track purchases, quantities, and the like associated with specific tradesmen and trade companies. The wholesaler or jobber can target their marketing to these specific industries and thereby provide service to expanding markets. Payment at point of purchase is also enabled through use of the Tradesman Purchase System. This decreases overhead and rolling capital needed for the wholesalers or jobbers who traditionally extend lines of credit to individual companies. With use of the Tradesman's Purchase System, lines of credit will be established by the credit issuer, so that the tradesman can purchase his or her goods and the wholesaler immediately receives the payment. A tradesman using The Tradesman's Purchase System would be nationally recognized. The tradesman would qualify for special pricing and would have his/her profession validated. Moreover, a tradesman could simply apply for and receive a single Tradesman's Purchase System from the issuer to be utilized with a variety of wholesalers so that the tradesman does not have to apply for lines or credit from each individual wholesaler. With utilization of a Tradesman's Purchase System, a tradesman's purchases would be processed in a biometric reader or a fingerprint imprint machine. The tradesman provides the unique identification number for the Tradesman's Purchase System. Consequently, any purchase at a predetermined wholesaler or jobber within the tradesman's profession automatically confers a pre-negotiated discount for goods and services purchased and used professionally by the tradesman.

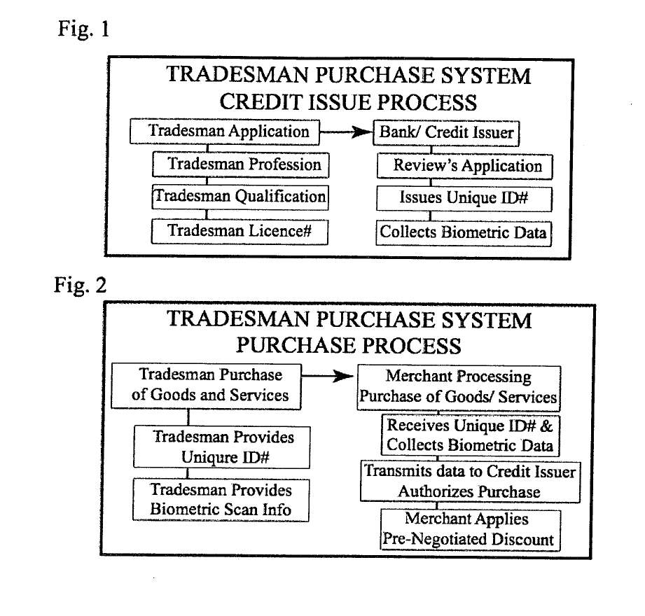

FIG. 1 illustrates a schematic view of the processes used to create the unique ID for Tradesman's professional purchases at pre-negotiated discount rates. The tradesman applies for the privileges of this cardless credit arrangement by providing to a bank or credit issuing authority, the tradesman's name, business address, professional affiliation, license number and professional status. The bank or credit issuing authority reviews the application and if found suitable issues a Tradesman's purchasing credit unique ID#. This unique ID# is linked to an initiation date expiration date and a security code. Additionally, the bank or credit issuing authority collects biometric data of the tradesman including palm print data, fingerprint data, iris scan data voice data which are also linked to the unique ID#. Upon payment of the initiation and periodic maintenance fees, the bank or credit issuing authority provides the tradesman with a list of merchants and jobbers that provide per-negotiated discount levels during purchase.

FIG. 2 illustrates schematically, the steps involved when the tradesman makes a purchase at merchants or jobbers that have pre-negotiated discount agreements with the bank or credit issuing authority. The tradesman merely provides the unique ID# and the devices present at the merchant location collect one or more of the biometric data which may be palm print, fingerprint, iris scan or voice print data. Upon being collected, the unique ID# and biometric data are transmitted to the bank or credit issuing authority electronically and the bank or credit issuing authority approves the purchase. The merchant cash register applies appropriate pre-negotiated discount levels for the purchase. Details of the transaction are mainted at the bank or credit issuing authority and report of the tradesman's professional purchases are provided to the merchant upon payment of a fee. The merchant may choose to increase the discount level or provide special incentives to the tradesman. The Tradesman Purchase System provides a paperless transaction that is secure and can only be used by the tradesman since the biometric link is preset and provides per-negotiated discounts and additional benefits based on the amount of professional purchases.

The Tradesman Purchase System may feature a low setup or initiation fee of $100.00 for a new jobber; a $50.00 annual fee that provides identification in a directory of suppliers issued to all members of the Tradesman Purchase System; and a $25.00 annual fee for a tradesman. The sponsoring manufacturers of goods, wholesalers or jobbers may pay (i) an initial fee as a part of sponsoring the Tradesman's Purchase System; and (ii) a further fee on a periodic basis to continue to receive reports on tradesman's professional purchases.

Utilization of The Tradesman Purchase System provides industry recognition of trades and tradesmen, and yields clear advantageous for participating jobbers or wholesalers, manufacturers, and tradesmen. For the jobber or wholesaler, these advantageous include: (a) almost immediate cash received at point of sale; (b) freed up receivables; (c) recognition of a genuine tradesman; and (d) increased business derived from the ability to reach out to more customers without having to finance the expanded receivables. Consequently, prices can be generated in accordance with pre-negotiated discounts to a tradesman that constitutes a member selected from the group consisting of plumbers, electricians, carpenters, masons, mechanics, repair shop professionals, contractors, and related construction or trade companies and professions; such pre-negotiated discounts can be applicable to purchases made at professional trade companies, such as wholesalers or jobbers. Prime advantages to the tradesman include: (1) recognition by any participating jobber/wholesaler, as the professional would no longer be commingled with the weekend home repair amateur; (2) benefit from discounts in related industries, such as car and truck rentals, equipment leasing, and the like; and (3) benefit from direct discount of supplies from wholesaler/jobber, or from the manufacturer. The Tradesman's Purchase System sponsoring manufacturers of goods or wholesalers or jobbers are provided with timely information of tradesman's professional supplies buying patterns thereby providing the capability to adjust incentives, discounts delivered to a tradesman for purchases as well changing advertising practices to target a specific market segment.

The Tradesman's Purchase System comprises, in combination, the following salient features:
1. a Tradesman's Purchase System issued to a tradesman selected from the group consisting of plumbers, electricians, carpenters, masons, mechanics, repair shop professionals, contractors, or related construction or trade companies and professionals has a Tradesman's purchasing credit unique ID#;
2. the Tradesman's purchasing credit unique ID# being issued by a bank or credit issuing authority upon payment of an initiation fee and periodic maintenance fees;
3. the tradesman being provided with a list of wholesalers and jobbers that have agreed to provide a pre-negotiated discount for purchase of trade merchandise and services;
4. the Tradesman's purchasing credit unique ID# is linked to the name of the tradesman; the tradesman's business name; the tradesman's license number; the initiation date and the expiration date and a security code;
5. the Tradesman's purchasing credit unique ID# is linked the tradesman's biometric information, which can comprise palm print scan data, fingerprint scan data, iris scan data and voice print data;
6. use of said Tradesman's Purchase System by a tradesman for the purchase of merchandise at said wholesalers or jobbers results in automatic generation of pre-negotiated discounts for said trade purchases;
7. trade purchases by the tradesman being tracked by the bank or credit issuing authority, and data concerning the purchases being analyzed to provide valuable marketing information for manufacturers of goods, service providers and wholesalers on a fee payment basis;
whereby the tradesman's profession is recognized by presentation of the Tradesman's Purchase System at wholesaler and jobber locations, providing discounts for trade specific goods and services purchased and used professionally by the tradesman, and the unique ID may not be used by anyone other than the tradesman, due to a strong biometric link that prevents fraudulent charges.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A Tradesman's Purchase System, comprising:
a. a Tradesman's purchasing credit issued to qualifying a tradesman selected from the group consisting of plumbers, electricians, carpenters, masons, mechanics, repair shop professionals, contractors, or related construction, trade companies or professionals upon payment of an initiation fee and payment of periodic maintenance fees;
b. said Tradesman's purchasing credit having a unique ID# appointed for issuance by a bank or credit issuing authority;
c. Tradesman's biometric scan data being linked to said Tradesman's purchasing credit unique ID#;
d. said Tradesman's purchasing credit unique ID# having linked information of the name of the tradesman, the tradesman's business name and tradesman's license number;
e. said tradesman being provided with a list of wholesalers and jobbers that have agreed to provide a pre-negotiated discount for purchase of trade merchandise and services using said Tradesman's purchasing credit;
f. use of said Tradesman's Credit Purchase System by a tradesman for the purchase of merchandise at said wholesalers or jobbers using Tradesman's purchasing credit unique ID# and biometric scan data results in automatic generation of pre-negotiated discounts for said trade purchases;
g. said trade purchases by the tradesman being tracked by said bank or credit issuing authority and purchase information being analyzed to provide valuable marketing information for manufacturers of goods, service providers and wholesalers on a fee payment basis;
whereby the tradesman's profession is recognized by presentation of the Tradesman's Purchase System at wholesaler and jobber locations, and discounts are provided for trade specific goods and services purchased and used professionally by the tradesman.

2. A Tradesman's Purchase System as recited by claim 1, wherein said qualification of a tradesman for a Tradesman's purchasing credit unique ID# includes an evaluation of professional licenses and company affiliation.

3. A Tradesman's Purchase System as recited by claim 1, wherein said biometric scan data includes palm print scan data of the tradesman.

4. A Tradesman's Purchase System as recited by claim 1, wherein said biometric scan data includes fingerprint scan data of the tradesman.

5. A Tradesman's Purchase System as recited by claim 1, wherein said biometric scan data includes eye iris scan data of the tradesman.

6. A Tradesman's Purchase System as recited by claim 1, wherein said biometric scan data includes voice print data of the tradesman.

7. A Tradesman's Purchase System as recited by claim 1, wherein said Tradesman's purchasing credit unique ID# is linked to an initiation date, expiration date and security code which may be additionally provided during purchase by the tradesman.

8. A Tradesman's Purchase System as recited by claim 1, wherein said discount on trade purchases by the tradesman is provided by communication between a biometric scan device and Tradesman's purchasing credit unique ID# and said bank or credit issuing authority, which automatically sets discount levels for trade merchandise at cash register checkout.

9. A Tradesman's Purchase System as recited by claim 1, wherein said Tradesman's Purchase System provides a tradesman with instant credit for trade specific purchases without having to open charge accounts at a plurality of wholesalers, jobbers or other commercial organizations.

10. A Tradesman's Purchase System as recited by claim 1, wherein said Tradesman's Purchase System relieves wholesalers, jobbers or other commercial organizations from opening credit lines for a tradesman in order to attract the tradesman's business purchases.

11. A Tradesman's Purchase System as recited by claim 1, wherein said Tradesman's Purchase System is sponsored by manufacturers of goods, service providers and wholesalers upon payment of an initial sponsorship fee and periodic payment of fees for tradesman professional purchase reports.

12. A Tradesman's Purchase System as recited by claim 11, wherein said professional purchase reports include brand specific purchase details and product details that indicate end use customer preferences.

13. A Tradesman's Purchase System as recited by claim 11, wherein said manufacturers of goods, service providers and wholesalers establish additional discounts for tradesman professional purchases, or provide incentives.
